(19) United States
(12) Patent Application Publication
(10) Pub. No.: US 2008/0088639 A1
(43) Pub. Date: Apr. 17, 2008

(54) METHOD FOR GENERATING A GRAPHICAL USER INTERFACE

(75) Inventor: Johan Thoresson, Goteborg (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/549,131

(22) Filed: Oct. 13, 2006

(51) Int. Cl. G09G 3/00

(52) U.S. Cl. 345/584

(57) ABSTRACT

A method for generating a graphical user interface (GUI) on a display of an electronic device such as a mobile phone, includes the steps of analyzing a bitmap, comprising a layout of fields of different colors, to determine the color and location of the fields. Each field represents the intended presence of a GUI object, such as an icon or a text field. The type of GUI object intended is determined in an interpretation file, which links color to GUI object type. The actual content to present in the field of a determined type, is then determined by accessing a table linking content description to field location, and the determined content is subsequently presented at the determined location on the display.

### FIELD OF THE INVENTION

The present invention relates to electronic devices comprising a display for presentation of information, such as computers, mobile phones, media players and so on. More specifically, the invention involves a method for generating a graphical user interface (GUI) for presentation of information on the display. The invention comprises the feature of defining a layout for the GUI using a bitmap with fields of different colors, which bitmap is interpreted in the device to provide the correct information at the correct places in the GUI.

### BACKGROUND

The use of electronic devices such as computers, mobile phones, and audio/video equipment has had enormous development in the world in the last decades. A lot of effort has been made in making smaller electronic devices, in particular for portable use, such as mobile phones, laptop computers, Personal Digital Assistants (PDA), mp3 players, and so on. Much help has been obtained from the miniaturization of electronic components and the development of more efficient batteries. In mobile communications, the communication systems have gone from analogue to digital, and at the same time the dimensions of the communication mobile phones have gone from briefcase size to the pocket size phones of today, in only a couple of decades. Still today, mobile phones are getting smaller and smaller and the size is generally considered to be an important factor for the end customer.

Regarding mobile phones as well as portable computers and PDA:s, the end users have a number of conflicting requirements. Basically, the device should be as small and light-weight as possible. Furthermore, it should provide more and more advanced functions, have a long battery time, and have a user-friendly interface. Still, there is only so much space in an electronic device, and in order to be competitive the elements of the device must be carefully packaged. The compact size of e.g. mobile phones also means that the user interface, typically a display and a set of keys, is limited. In order to access the different functions and stored items, different types of menu systems are therefore often employed. Furthermore, the use of icons representing e.g. a set of data, a program, or an action, has also be introduced in the art of mobile telephony. A graphical user interface is often configured such that a plurality of icons are presented on a desktop screen, each representing a certain subject. Clicking on one of the icons, or activation in any other way of the icon, using the user input interface of the electronic device typically results in the presentation of a menu associated with the subject.

A problem related to the issue of generating GUI layouts for electronic devices, particularly portable devices such as mobile phones, is that the devices generally makes use of one or more generic layouts for use in different themes. The layouts are typically hard coded into the software residing in the devices, and cannot be changed in an easy way. Furthermore, the layouts are often quite complex and a lot of work is generally required from both design engineers and software engineers before a final product is obtained. Today, one method used is to have design engineers create GUI layout documents, including sketches of the layouts with different associated measurements, such as offsets, heights and widths of objects and so on. This work is both cumbersome and time-consuming.

### SUMMARY OF THE INVENTION

A general object of the invention is therefore to provide a solution for simplified generation of GUI layouts for electronic devices. According to an aspect of the invention, this object is fulfilled by means of a method for generating a graphical user interface on a display of an electronic device, comprising the steps of analyzing a bitmap, comprising a layout of fields of different colors, to determine the color and location of the fields; determining user interface object type for the fields by accessing an interpretation file linking color to user interface object type; determining content of the fields by accessing a table linking content description to field location; and presenting the determined content at the determined location on the display.

In one embodiment, the step of analyzing the bitmap comprises the step of scanning the bitmap to determine the location of a colored field.

In one embodiment, the step of analyzing the bitmap comprises the steps of scanning pixels of the bitmap to detect a color change from one pixel to the next; scanning pixels neighboring said next pixel, to determine borders of a contiguous field of pixels having the same color.

In one embodiment, one color represents a text field.

In one embodiment, one color represents an icon.

In one embodiment, one color represents a picture.

In one embodiment, one color represents a highlight, such that a field of that color encompassing an inner field in the bitmap represents highlighted presentation of content in that inner field.

In one embodiment, the electronic device is a mobile phone.

In one embodiment, the table lists content for fields in a predetermined order corresponding to a layout order of the fields in the bitmap.

In one embodiment each field in the bitmap is rectangular.

### BRIEF DESCRIPTION OF THE DRAWINGS

FIG. 1 schematically illustrates an electronic device in the form of a mobile phone, configured to be operated in accordance with an embodiment of the invention;

FIG. 2 schematically illustrates functional blocks of the electronic device of FIG. 1;

FIG. 3 schematically shows a GUI layout for use in a mobile phone created as a bitmap;

FIG. 4 illustrates a presented screen on a display of a mobile phone, based on the bitmap layout of FIG. 3;

FIG. 5 schematically illustrates the communicative relation between different entities in the process of generating a GUI screen on the display of a mobile phone, based on a bitmap layout.

### DETAILED DESCRIPTION OF PREFERRED EMBODIMENTS

The present description relates to the field of electronic devices comprising a display for presentation of information. As already mentioned, there are many different types of electronic devices in which the present invention may be employed, which are all devised with a display. Henceforth, the invention will be described in the context of mobile communications, i.e. where the electronic device is a radio communication terminal such as a mobile phone. Furthermore, it should be emphasized that the term comprising or comprises, when used in this description and in the appended claims to indicate included features, elements or steps, is in no way to be interpreted as excluding the presence of other features, elements or steps than those expressly stated.

Examples of embodiments will now be described with references made to the accompanying drawing.

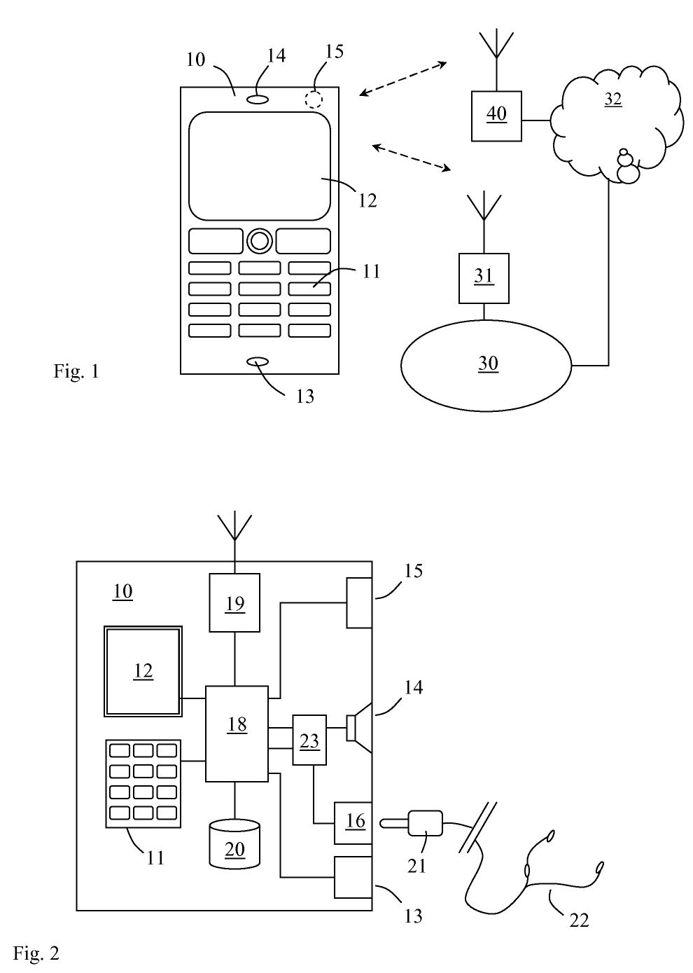

FIG. 1 illustrates the outer appearance of an electronic device in the form of a typical mobile phone 10, which may be configured to employ an embodiment of the present invention, whereas FIG. 2 schematically illustrates functional features of the mobile phone by means of a block diagram. It should be noted that the elements indicated in FIG. 2 need not necessarily be physically divided in the manner shown, as it is the functional relationship rather than the structural arrangement that is shown in the drawing of FIG. 2. Furthermore, the outer appearance of the mobile phone need not take the indicated shape of FIG. 1, instead the mobile phone may e.g. be of a clamshell type, a jack knife type, or the like.

Mobile phone 10 is configured to operate in a cellular radio communications network 30, by radio communication with a base station 31, or by direct radio communication with another mobile phone as a walkie-talkie. The radio communications network 30 may e.g. be a GSM network or a WCDMA 3G network. In addition, mobile phone 10 may be provided with a radio signal transceiver configured to operate in a IEEE 802.11 WLAN over an access point 40 connected to the Internet 32.

The mobile phone 10 includes a user interface comprising an input part, preferably including a set of keys 11, and additionally or optionally a touch-sensitive display. An output part of the user interface includes a display 12 for presenting information to a mobile phone user. For the purpose of conducting speech communication, mobile phone 10 further preferably includes a microphone 13 and a speaker 14. Besides speaker 14, an additional speaker (not shown) may be employed inter alia for the purpose of providing alert signals to a mobile phone user, and as a loudspeaker. Otherwise, or in addition, speakers for presenting audio, such as music, to a user are typically provided in the form of a headset 22, which is communicatively connectable to the mobile phone. Mobile phone 10 may also include a digital camera 15. Typically, the camera 15 is placed on an opposite side of where display 12 is arranged, such that the display may be used as a viewer, which is why camera 15 is illustrated in phantom in FIG. 1. Additionally, another camera for video conferencing purposes (not shown) may be included on the same side as the display.

FIG. 2 illustrates the mobile phone 10 in the form of a block diagram. The actual function of mobile phone 10 as a radio communications device is not crucial to the invention, and will therefore not be described in detail. A radio signal transceiver 19 is included for transmission and reception of radio signals to and from a radio network or a radio terminal. As an example, the radio signal transceiver 19 may include an antenna and circuitry configured to transmit and receive communication signals over the mobile phone network 30. Other possible additional or alternative transceiver systems 19 may include an antenna and circuitry configured to receive radio signals over a direct WLAN Internet connection, or using a short range protocol such as bluetooth. The radio transceiver 19 is connected to a controller 18, which in a preferred embodiment represents a microprocessor system with associated memory space, operation software, and application software. Controller 18 is depicted in FIG. 2 as a central element, responsible for carrying out different tasks of the mobile phone, such as controlling communication sessions as well as controlling camera 15 and managing the user interface. A socket 16 is also illustrated as an example of how an audio headset 22 may be attached using a plug 21. Alternatively, the headset may be wirelessly connected using e.g. a bluetooth connection. A battery (not shown) or a connection to an exterior power source is typically also included. A media player 23 may also be included, such as an mp3 player. Media player 23 may be configured to play both recorded media stored in a media file memory (not shown) either in the device 10 or on an attachable memory carrier, and media received as e.g. a streaming media signal over a mobile phone network 30 or from a broadcast source.

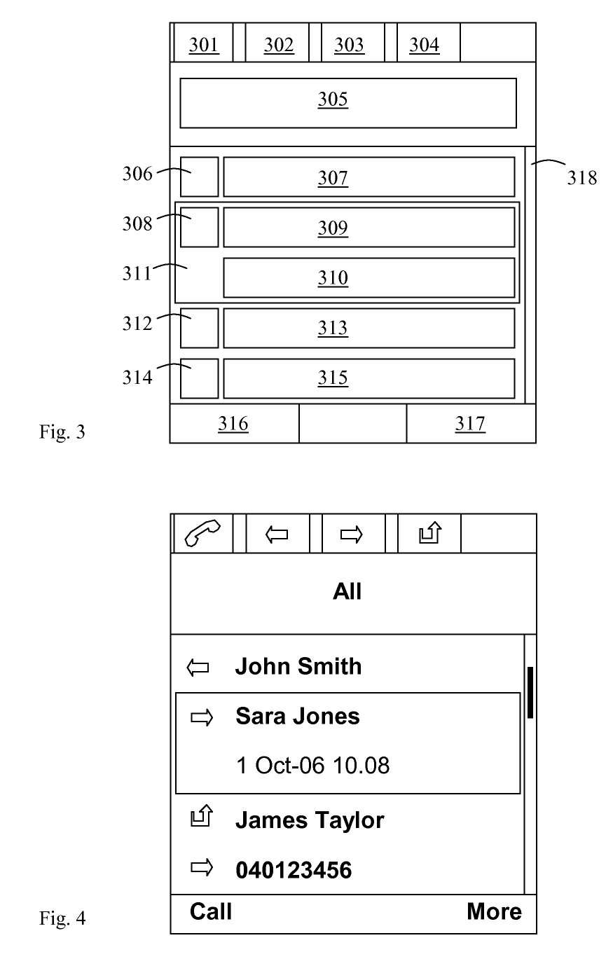

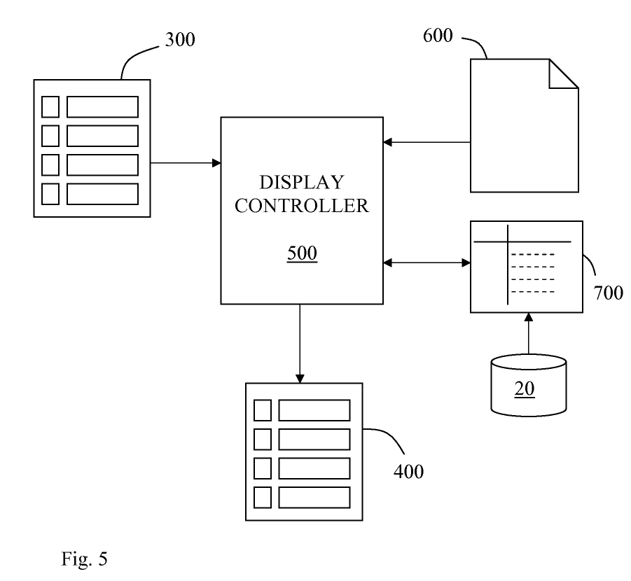

An embodiment of the invention will now be described with reference to FIGS. 3 and 4. FIG. 3 illustrates a GUI layout for use in a mobile phone, created as a bitmap 300. In a bitmap, each pixel is characterized by its color and its position. This is a simple set of characteristic which is used in the present invention as a code to determine the type of object to be presented, and the position of the object, respectively. As colored drawings are not usable in patent applications, the description will be given here with reference to fields identified by their contours in FIG. 3. In the example of the layout shown in the drawing, 18 fields 301-318 are identified. There are also borders depicted for other unidentified specific fields, and fields encompassing one or more of the identified fields, as will be briefly mentioned. The GUI layout of FIG. 3 represents a screen of a call list, and in FIG. 4 the actual screen 400 as presented on the display 12 based on the layout of FIG. 3 is shown. In FIG. 4, the information presented in the respective fields has been retrieved from a memory 20 in the electronic device 10. In FIG. 3, fields 301-304 represent different tabs for identifying which one of four windows is presently shown. These fields are therefore of the same type, and are hence of the same primary color in the bitmap, e.g. Color 1. However, dependent on which tab is selected, that tab is preferably highlighted in some way in the presented screen. In FIG. 4, tab 301 would be highlighted in such an embodiment. Fields 301-304 are icon or symbol type objects, and the respective icons are shown in FIG. 4. Here, the first tab 301 represents “All” calls, the second tab 302 represents “Answered” calls, the third tab 303 represents “Dialed” calls, and the forth tab 304 represents “Missed” calls. The fields dividing the tab fields 301-304 from each other preferably represent a background field, having a background Color 2. Field 305 is a text field giving the title of the presented menu, having a Color 3 representing text fields. In FIG. 4 the screen represented by the leftmost tab 301 is shown, for which the title is “All”.

Under the title field 305 a number of items are listed. In the first row a field 306 is an icon field indicative of the type of call, i.e. answered, dialed or missed, whereas the adjacent field 307 is a text field to be used for providing a contact ID of a call in the call list. Corresponding pairs of fields are given in subsequent rows, with icon field 312 next to text field 313, and icon field 314 next to text field 315. An intermediate set of fields is also provided, which represents a currently selected item in the call list, with an icon field 308 representing type of call and associated text field 309. Another field may also be included representing a picture (not shown) of a person linked to the selected contact, where this field has a special color representing pictures. Furthermore, an additional text field 310 associated with that call is also given, for introduction of a time stamp related to the call in question. In one embodiment, a highlight field 311 is also included, encompassing fields 308-310, and it is only the highlighted call for which the time stamp is shown. Typically, at least fields 306, 312, and 314 have the same color in the bitmap, e.g. Color 4, whereas at least text fields 307, 313, and 315 have the same color, Color 5. The highlighted call, i.e. fields 308-310, may have another set of colors, Color 6 for icon field 308 and Color 7 for text fields 309 and 310. In such an embodiment, those colors 6 and 7 would represent highlighted GUI objects, and there is no need for a specific highlight field 311. Alternatively, also fields 308-310 have the respective Colors 4 and 5. This is merely a matter of choice in the coding principle. At the bottom of the screen two fields 316 and 317 are given, representing softkey text fields, having a certain Color 8. A scrollbar may also be provided, indicated by field 318, having its own Color 9.

As mentioned, FIG. 4 shows how a screen of the call list will look like, when built on the bitmap GUI layout of FIG. 3, according to an embodiment of the invention. It should be noted, though, that the pixel size of the bitmap and the display on which the screen is generated need not be identical. Instead, it is the relative location of field in the bitmap which is translated to a corresponding relative position of the associated GUI object on the presented screen. Typically, the screen is built up by using a scanning process in the electronic device to analyze the bitmap, so as to locate each color field in the bitmap, and to determine the color of each field. This may be done either once, when a certain theme with a set of associated layouts is set for the electronic device, or every time the screen is to be shown. In one embodiment, a scanning process starts from the first pixel at the uppermost left corner, and reads the first pixel row. When the scanning process enters field 301, the color thereof is detected. The scanning process may then continue row by row to determine the extent of that field 301. However, in a preferred embodiment a field scanning process is instead initiated, in which neighboring pixels of the first detected pixel of field 301 are investigated. As an example, assume that the first detected pixel of field 301 is line 1 column 10. The scanning process then continues to scan line 1 until a different color is detected, whereby the right side end of field 301 is detected. Preferably, all fields are rectangular, and thereby it is known that the width of the preceding field has been determined when the color changes. Therefore only the height of the field 301 remains to be determined, which is achieved by following one of the pixel columns of the detected first row of field 301 downwards until the color changes again. The color and entire position, i.e. also size, of field 301 has thereafter been determined, and the scanning process may continue towards the left from the end of the first field along the first pixel row. Field 302 will then be detected, and subsequently completely determined. This process will continue until the final column of the bitmap has been reached. In the example of the illustrated embodiment, the process may continue with the first row below fields 301-304, and subsequently text field 305 is detected. Following the same process all the way through the bitmap, all positions and colors of the included fields are determined.

In order to read the bitmap, i.e. in order for the electronic device to understand how to fill the determined fields, a number of steps have to be carried out. This is schematically illustrated in FIG. 5. A display controller 500, which may form part of controller 18 of FIG. 2, analyzes bitmap layout 300, which is stored in a memory, such as a part of memory 20, to determine location and color of any GUI field included in the layout as described above. Display controller 500 then accesses an interpretation file 600, also stored in the electronic device. The interpretation file 600 links bitmap color to user interface object type, and preferably defines that e.g. Color 1 means icon for call type, Color 2 means background color or pattern, Color 3 means menu title text field, and so on. The interpretation file 600 may be common for all layouts. Alternatively, a dedicated interpretation file may be provided to the electronic device together with the actual bitmap to which it relates. This way, an entire theme may be downloaded and stored in a memory 20 of the electronic device, which can easily be analyzed and determined according to the embodiment described herein. In order to fill out the screen with the correct GUI objects, a table 700 linking content description to field location is accessed. Using this table 700 the actual data to be presented is retrieved from a memory 20, such as the title of the menu, the names or telephone numbers of the call list, the icon images, and so on. Preferably, the content of GUI objects in the table 700 is listed in the order of how the bitmap 300 is scanned. As an example, based on FIG. 3, the scanning process reveals that the upper part of the bitmap layout comprises four fields 301-304 of Color 1, which by means of interpretation file 600 are determined to represent window tabs. Preferably table 700 includes four, or more, GUI objects representing window tabs, listed in the order they are to be presented. This way, a process scanning table 700 reads a first window tab symbol and presents it in field 301, subsequently reads a second window tab symbol and presents it in field 302, and so on until tab field 304. Even if there are more window tab symbols in the table 700, the next field detected in bitmap 300 is the title text field 305. The scanning of table 700 therefore disregards any such further window tab symbols in the table 700, and continues to scan table 700 for the first detected title text, which is then placed in field 305. When it comes to the actual call list, i.e. the stored content of the call list, that list may of course be much longer than what fits on the screen. The data to be inserted in fields 306-315 is therefore a subset of four call items fetched from a list of all calls stored, and which four to present is determined by detection of how a navigation tool on the input interface 11 is operated. Following this generally outlined principle, display controller 500 is configured to generate the displayed screen 400 using the bitmap 300, the interpretation file 600, and the table 700.

The invention has been described in the context of a mobile phone, but may be applied to any electronic device with a display and circuitry configured to control which data to display. Furthermore, the specific embodiment of a call list as shown in the drawings is merely an example chosen to indicate the principles of the invention, as defined by the appended claims.

What is claimed is:

1. Method for generating a graphical user interface on a display of an electronic device, comprising the steps of:
analyzing a bitmap, comprising a layout of fields of different colors, to determine the color and location of the fields;
determining user interface object type for the fields by accessing an interpretation file linking color to user interface object type;
determining content of the fields by accessing a table linking content description to field location;
presenting the determined content at the determined location on the display.

2. The method of claim 1, wherein the step of analyzing the bitmap comprises the step of:
scanning the bitmap to determine the location of a colored field.

3. The method of claim 1, wherein the step of analyzing the bitmap comprises the steps of:
scanning pixels of the bitmap to detect a color change from one pixel to the next;
scanning pixels neighboring said next pixel, to determine borders of a contiguous field of pixels having the same color.

4. The method of claim 1, wherein one color represents a text field.

5. The method of claim 1, wherein one color represents an icon.

6. The method of claim 1, wherein one color represents a picture.

7. The method of claim 1, wherein one color represents a highlight, such that a field of that color encompassing an inner field in the bitmap represents highlighted presentation of content in that inner field.

8. The method of claim 1, wherein the electronic device is a mobile phone.

9. The method of claim 1, wherein the table lists content for fields in a predetermined order corresponding to a layout order of the fields in the bitmap.

10. The method of claim 1, wherein each field in the bitmap is rectangular.
